(19) United States
(12) Patent Application Publication
(10) Pub. No.: US 2010/0136924 A1
(43) Pub. Date: Jun. 3, 2010

(54) ANTENNA DEVICE AND WIRELESS COMMUNICATION SYSTEM

(76) Inventors: Takayoshi ITO, Kanagawa-ken (JP); Hiroki Shoki, Tokyo (JP); Shuichi Obayashi, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/628,747

(22) Filed: Dec. 1, 2009

(30) Foreign Application Priority Data
Dec. 2, 2008 (JP) 2008-307542

(51) Int. Cl. H04B 1/38; H01Q 9/04

(52) U.S. Cl. 455/73; 343/700 MS

(57) ABSTRACT

An antenna device includes a ground plane, an antenna element, and a metal wall. The antenna element is having a distance of (m×λ/2-λ/4) away from the ground plane, where “m” is an integer which is equal or larger than “1” and “λ” is a wave length of operating frequency. The metal wall is surrounding the antenna element. One end of the metal wall is attached to along the ground plane. The other end of the metal wall is forming an aperture with a height from the ground plane. The height of the metal wall is (n×λ/2), where “n” is an integer which is equal or larger than “m”.

### CROSSREFERENCE TO RELATED APPLICATIONS

This application is based upon and claims the benefit of priority from the Japanese Patent Application No. 2008-307542, filed on Dec. 2, 2008, the entire contents of which are incorporated herein by reference.

### BACKGROUND OF THE INVENTION

1. Field of the Invention

The present invention relates to an antenna device and a wireless communication system.

2. Description of the Related Art

Communication techniques for confidential data in wireless communication systems are disclosed in JP-A 2005-323149(KOKAI) and JP-A 2006-60470(KOKAI). In these references, the confidential data is transmitted with low power or low receiving gain to avoid leaking. For example, the confidential data may be authentication information such as security key. However, a circuit to control the power or the receiving gain is complex.

Other technique is disclosed in Japanese Patent No. 3669293. In this reference, the confidential data is transmitted/received with a dedicated antenna device which has limited coverage area. However, the dedicated antenna device is required for the confidential data in addition to an antenna device to transmit/receive other data.

### SUMMARY OF THE INVENTION

According to one aspect of the invention, an antenna device includes:

a ground plane;

an antenna element having a distance of (m×λ/2-λ/4) away from the ground plane, “m” being an integer which is equal or larger than “1”, “λ” being a wave length of operating frequency; and

a metal wall surrounding the antenna element, one end being attached to along the ground plane, the other end forming an aperture with a height from the ground plane, the height being (n×λ/2) where “n” is an integer which is equal or larger than “m”.

### BRIEF DESCRIPTION OF THE DRAWINGS

FIG. 1 is a perspective view of an antenna device according to the first embodiment;

FIG. 2 is a sectional view of a wireless communication system in the normal mode;

FIG. 3 is a perspective view of the wireless communication system in the secure mode;

FIG. 4 is a sectional view explaining an electric standing wave;

FIG. 5 is a sectional view explaining the electric standing wave;

FIG. 6 is a perspective view of an antenna device according to the second embodiment;

FIG. 7 is a sectional view of the wireless communication system in the secure mode;

FIG. 8 is a perspective view of an antenna device according to the third embodiment;

FIG. 9 is a top view of the wireless communication system;

FIG. 10 is an exploded perspective view of an antenna device according to the fourth embodiment;

FIG. 11 is an exploded perspective view of an antenna device according to the fifth embodiment;

FIG. 12 is a perspective view of the wireless communication system according to the sixth embodiment;

FIG. 13 is a perspective view of the wireless communication system in the secure mode; and

FIG. 14 is a perspective view of the wireless communication system in the normal mode.

### DETAILED DESCRIPTION OF THE INVENTION

The embodiments will be explained with reference to the accompanying drawings.

### (Description of the First Embodiment)

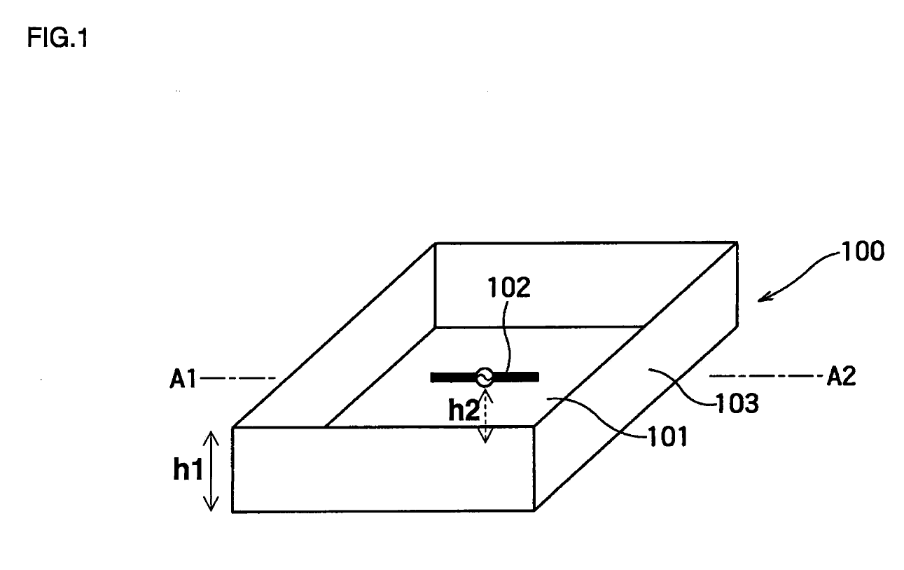

As shown in FIG. 1, an antenna device 100 includes a ground plane 101, an antenna element 102, and a metal wall 103 which is surrounding the antenna element 102. The ground plane 101 is made of metal and has a square shape.

The metal wall 103 is attached vertically to the ground plane 101. Height “h1” of the metal wall 103 is following (n×λ/2), where “n” is an integer which is equal or larger than “m”. “m” is an integer which is equal or larger than “1”. “λ” is a wave length of operating frequency.

The antenna element 102 is located at height “h2” away from the ground plane 101. The height “h2” is following (m×λ/2-λ/4).

The antenna element 102 may be a dipole antenna, a patch antenna, or a microstrip antenna, that generates an electric field which is parallel to the ground plane 101.

In the first embodiment, “m=1” and “n=1”. In this case, the height “h1” of the metal wall 103 is half the wave length of operating frequency. Moreover, the height “h2” of the antenna element 102 is quarter the wave length of operating frequency.

The metal wall 103 includes four plates. Ends of the plates are attached vertically to four sides of the ground plane 101, respectively. The other ends of the plates are forming an aperture plane. They may be attached not only vertically but also obtusely. The metal wall 103 may be formed by many via holes (described later).

Inside of the metal wall 103 may be an air space or filled with dielectric substrate. In the latter situation, the antenna element 102 is fixed in the dielectric substrate.

Shape of the ground plane 101 is preferably square. However, the shape may be any one of circle, ellipse, and other polygonal shapes.

In the first embodiment, a wireless communication system includes two radio apparatuses 100A, 100B. Each apparatus 100A, 100B adopts the antenna device 100. The wireless communication system performs two communication modes, which are a secure mode and a normal mode. In the secure mode, the confidential data are transmitted/received. In the normal mode, other data are transmitted/received.

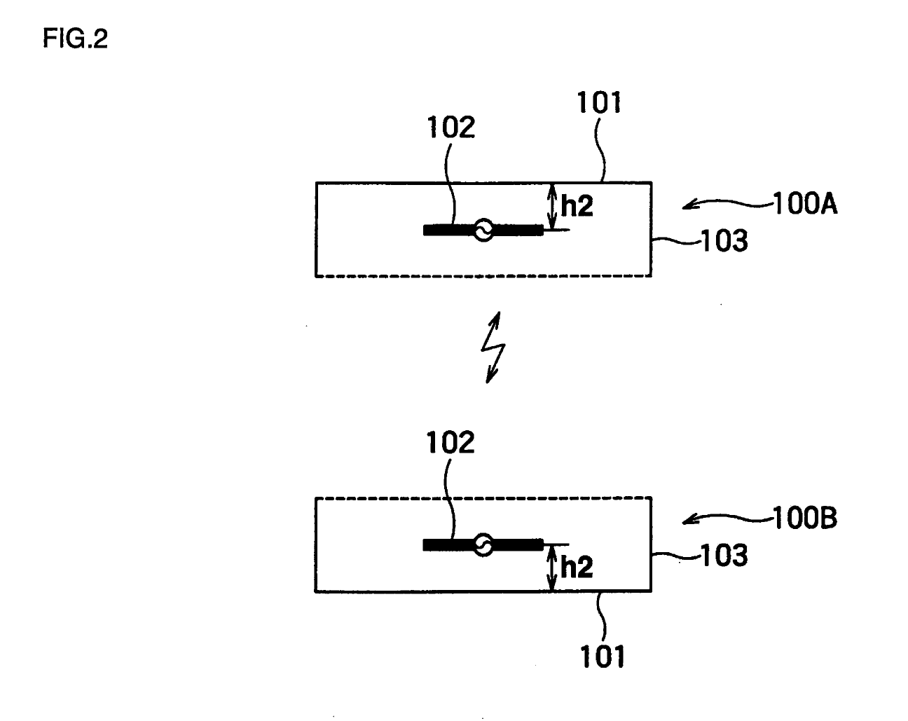

As shown in FIG. 2, the two radio apparatuses 100A, 100B communicate away from each other in the normal mode. The radio apparatuses 100A, 100B are shown as a cross-sectional view along line A1-A2 of FIG. 1. The radio apparatuses 100A, 100B face their aperture planes each other.

Edges of the metal wall 103 of the radio apparatuses 100A, 100B do not touch each other. The radio apparatus 100A, 100B works an antenna with reflector. Since the distance “h2” between the ground plane 101 and the antenna element 102 is quarter the wave length of operating frequency, a direct wave from antenna element 102 and a reflected wave by the ground plane 101 strengthen each other's power.

Therefore, although the radio apparatuses 100A, 100B are away from each other, they can achieve robust communication.

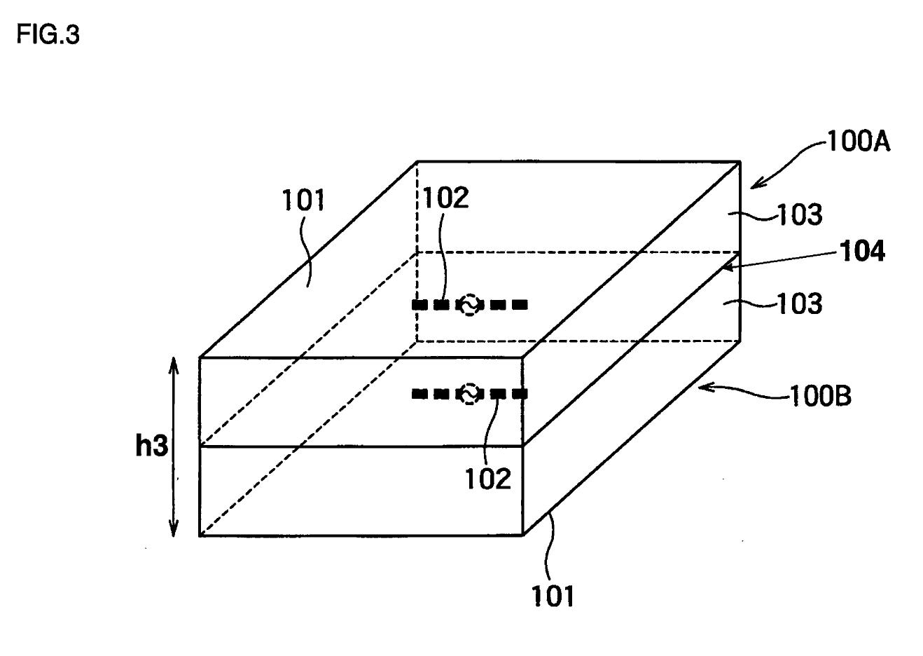

As shown in FIG. 3, the two radio apparatuses 100A, 100B are coupling by being in touch each other's edges 104 of the metal wall 103 in the secure mode. The antenna elements 102 of the radio apparatuses 100A, 100B are in a sealed space which is completely surrounded by the two ground planes 101 and the metal walls 103. Therefore, radio wave from the antenna element 102 does not go out of the sealed space.

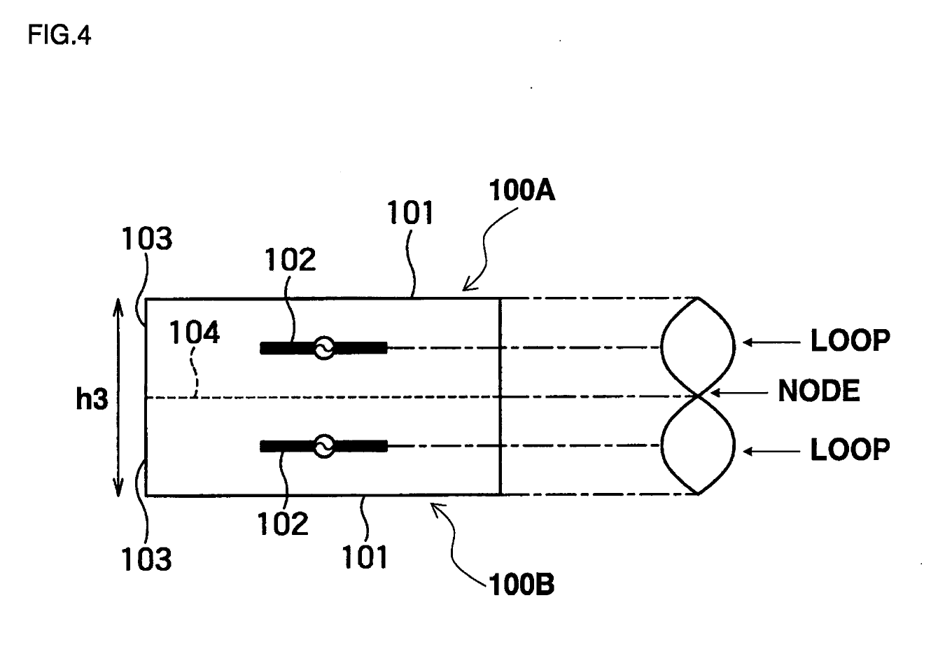

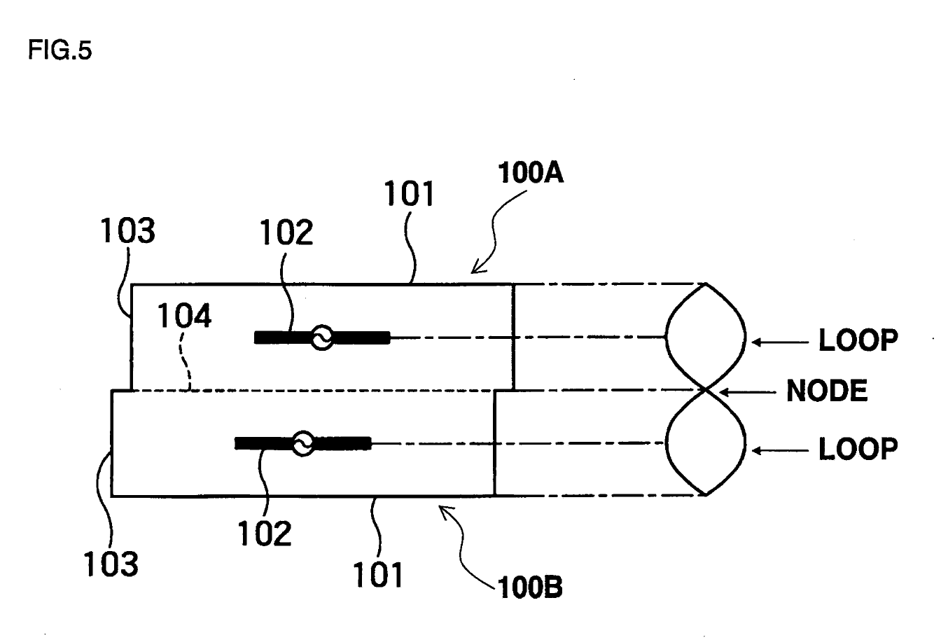

As shown in FIG. 4, since height “h3” is a wave length of operating frequency, these antenna elements 102 generates an electric standing wave having two loops and a node. The antenna elements 102 are located at the loops, respectively. Therefore, they can communicate in good condition. On the other hand, the touching edges 104 are located at the node. Therefore, as shown in FIG. 5, even when the edges 104 are slid to a horizontal direction, the leaked radio wave is less.

In this condition, the confidential data are transmitted/received securely in the sealed space. Moreover, the relationship with the two loops and the node is kept as long as the height “h1” of the antenna element 102 and the height “h2” of the metal wall 103 are following above equations.

According to the first embodiment, the wireless communication system realizes both communications in the secure mode and in the normal mode without controlling the power or having a dedicated antenna device for the confidential data in addition to the antenna device to transmit/receive other data.

### (Description of the Second Embodiment)

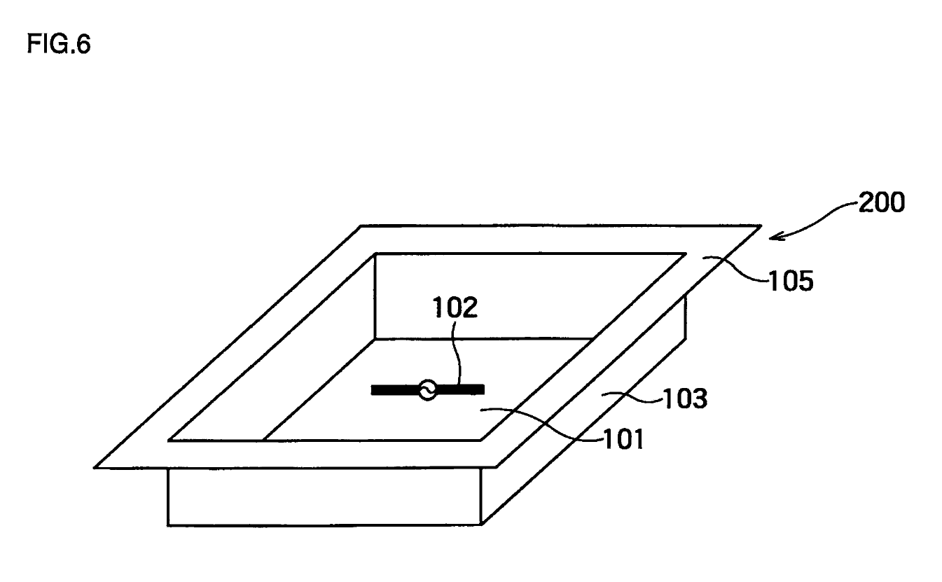

As shown in FIG. 6, an antenna device 200 is almost same as the antenna device 100 except for having a metal flange 105. The metal flange 105 is attached orthogonally on the edge of the metal wall 103.

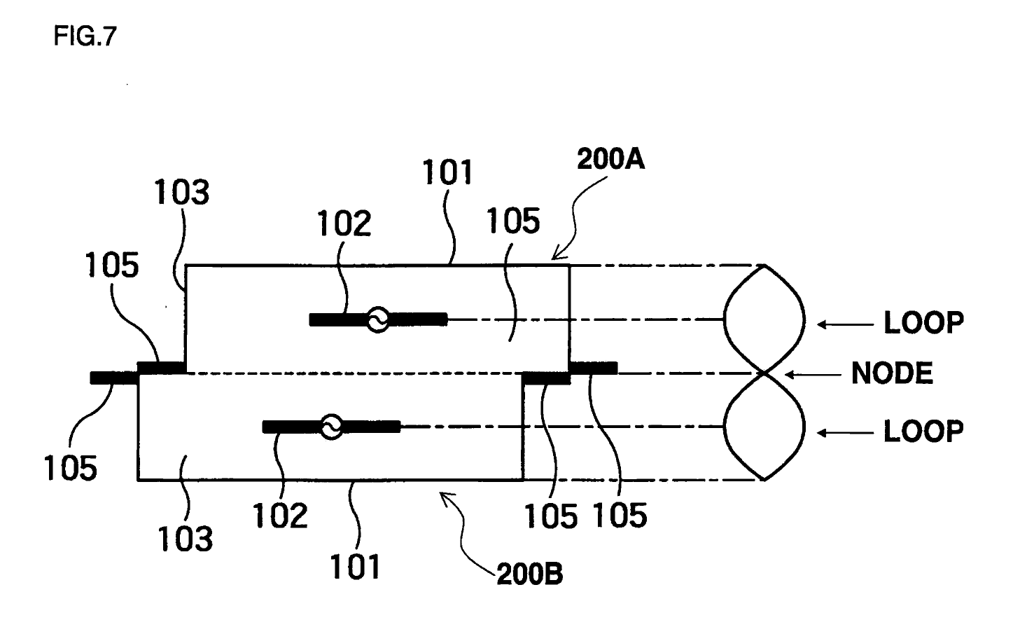

FIG. 7 shows a wireless communication system including two radio apparatuses using the antenna devices 200A, 200B in the secure mode. Even when the radio apparatuses 200A, 200B are slid to a horizontal direction, the aperture areas are shut by the metal flange 105 if the aperture area is smaller than size of the metal flange 105. Therefore, the radio wave is not leaked out of the sealed space.

According to the second embodiment, the wireless communication system realizes more secure communication when the aperture area exists due to slid.

### (Description of the Third Embodiment)

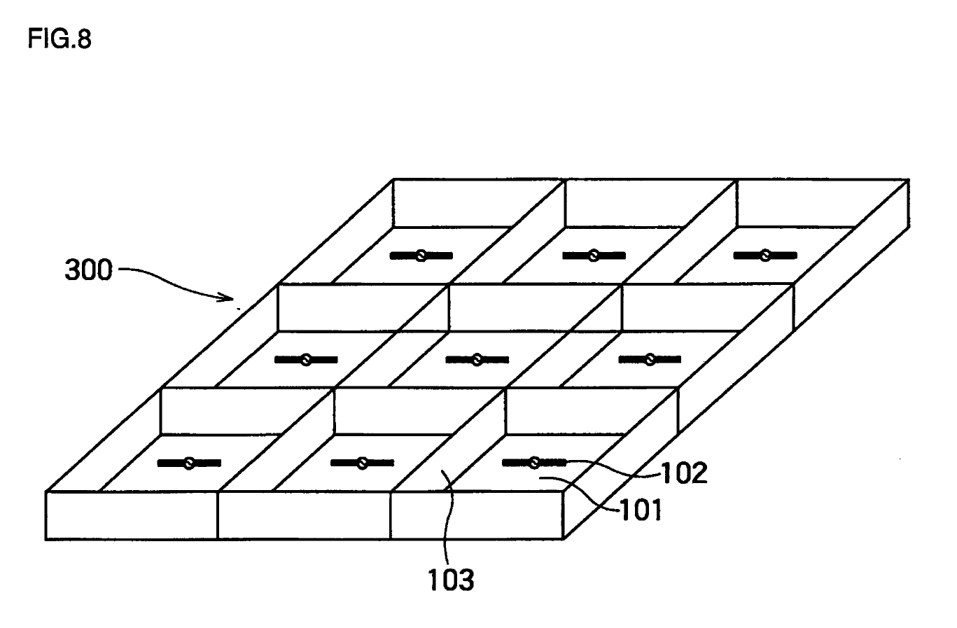

As shown in FIG. 8, an antenna device 300 includes several antenna devices 100 horizontally.

Each antenna devices 100 share a ground plane 101. Adjacent antenna devices 100 also share a part of the metal wall 103. The metal walls 103 may not be all same shapes. The antenna device 300 is easily made with semiconductor process.

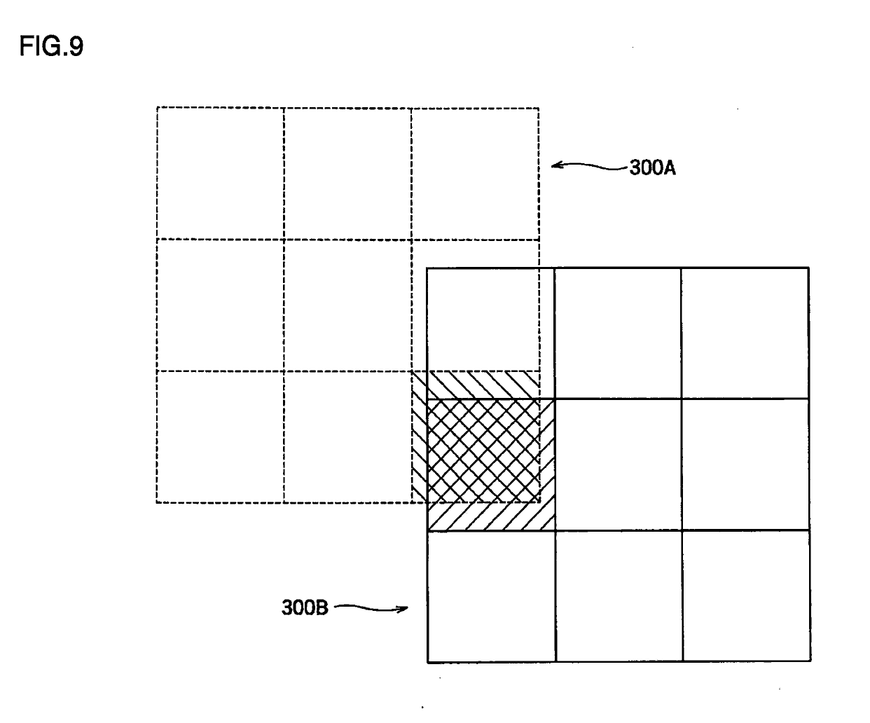

FIG. 9 shows a wireless communication system including two radio apparatuses using the antenna devices 300A, 300B in the secure mode. The antenna elements 102 are not shown in FIG. 9 for simplicity.

The antenna devices 300A, 300B are substantially slid for each other. However, the antenna elements 102 in a shaded area can realize a communication in the secure mode because the leaked radio wave would be less between the antenna devices 300A and 300B. The radio apparatus with the antenna device 300A and the radio apparatus with the antenna device 300B search a pair of the antenna elements 102 which can realize less leaked radio wave. Then, the radio apparatus with the antenna device 300A and the radio apparatus with the antenna device 300B perform communication in the secure mode by using the pair of the antenna elements 102.

According to the third embodiment, the antenna device 300 realizes a secure communication even when the antenna devices 300A, 300B are substantially slid each other.

### (Description of the Fourth Embodiment)

An antenna device 1000 in the fourth embodiment is almost same as the antenna device 100 except that inside of the metal wall 103 is filled with dielectric substrate.

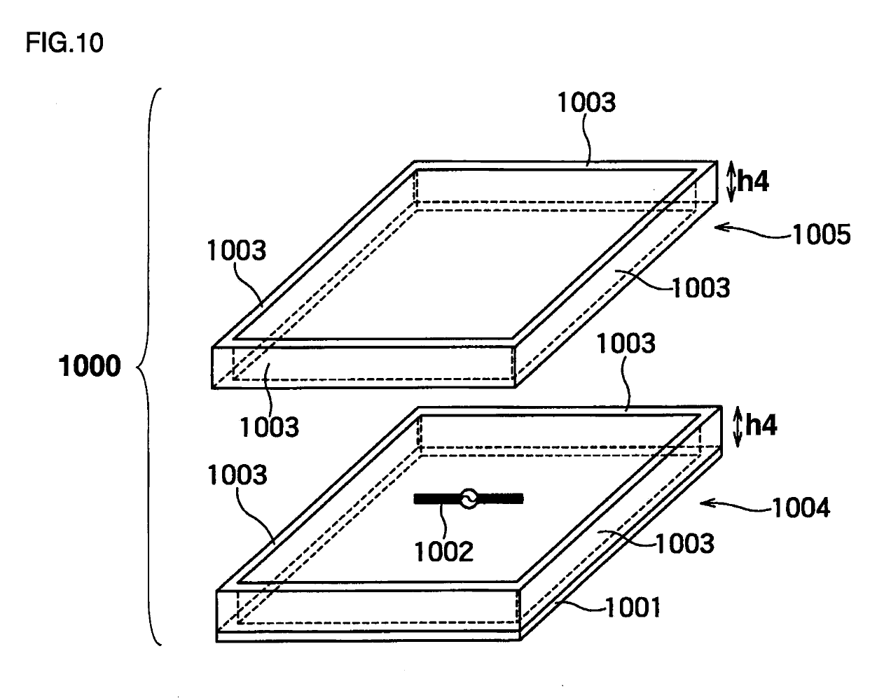

As shown in FIG. 10, the antenna device 1000 includes two layers of dielectric substrate, which are a lower layer 1004 and a upper layer 1005. An antenna element 1002 is formed on the lower layer 1004. The upper layer 1005 is piled on the lower layer 1004.

A ground plane 1001 is attached along the bottom of the lower layer 1004. The metal wall 103 includes several metal plates 1003. The metal plates 1003 are attached around the lower layer 1004. Moreover, other metal plates 1003 are attached around the lower layer 1005. The metal plate 1003 is made by common manufacturing process such as plating, etching, deposition. Therefore, production cost and variation of performance can be reduced.

The thickness “h4” of the lower layer 1004 and the upper layer 1005 is quarter the wave length of operating frequency. The wave length becomes shorter by the dielectric substrate compared with case of empty. The thickness “h4” also becomes smaller. Therefore, the antenna device 1000 can be downsized by the dielectric substrate.

### (Description of the Fifth Embodiment)

An antenna device 1100 in the fifth embodiment is almost same as the antenna device 1000 except that many via holes exist as the metal wall 103 instead of the metal plates 1003.

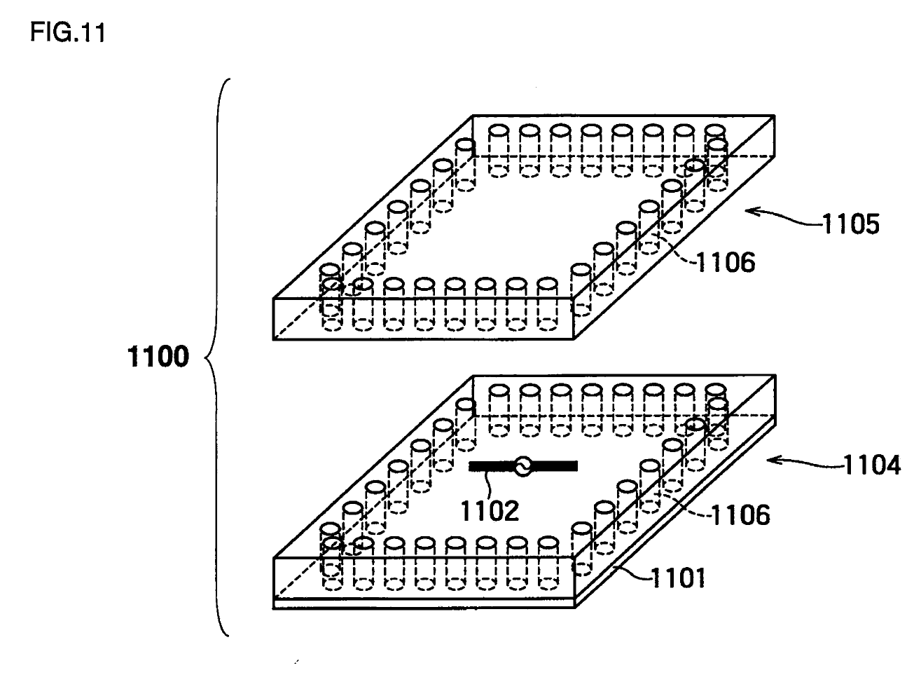

As shown in FIG. 11, the antenna device 1100 includes two layers of dielectric substrate, which are a lower layer 1104 and a upper layer 1105. The antenna element 1102 is formed on the lower layer 1104. The upper layer 1105 is piled on the lower layer 1104. The many via holes 1106 are put through the lower layer 1104 and the upper layer 1105. Interval between adjacent via holes 1106 is smaller than of the wave length. Inside of each via hole 1106 is coating by metal. Therefore, the via hole 1106 is connected to a ground plane 1101 electrically.

It is easier to form the via hole 1106 than the metal plate 1003. Therefore, the antenna device 1100 reduces more production cost compared with the antenna device 1000.

### (Description of the Sixth Embodiment)

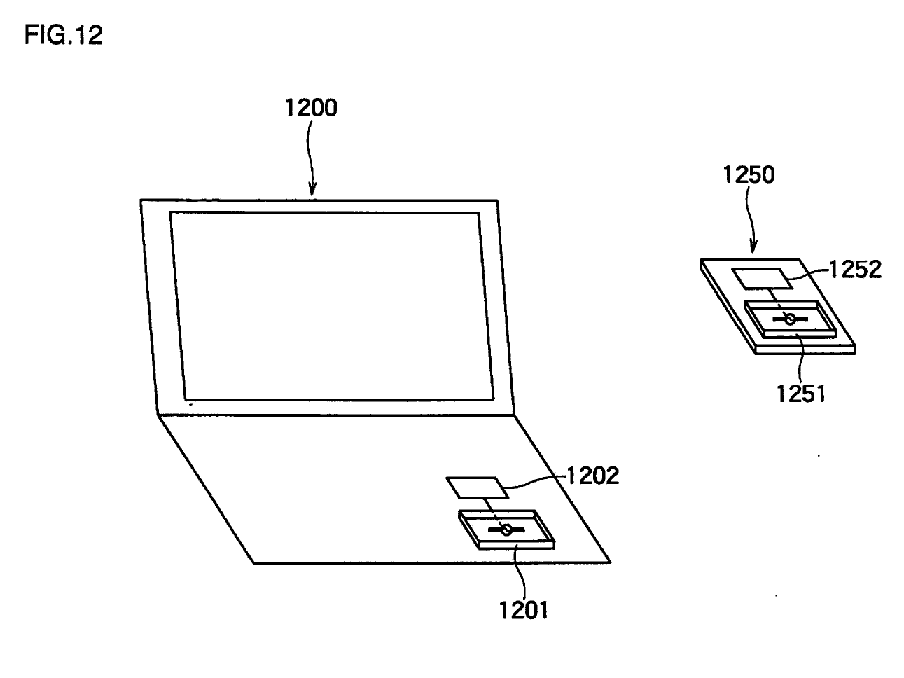

As shown in FIG. 12, a wireless communication system includes radio apparatuses 1200, 1250. The radio apparatuses 1200, 1250 adopt antenna devices 1201, 1251, respectively. The antenna devices 1201, 1251 are any of the antenna devices of the first to fifth embodiment. The antenna devices 1201, 1251 are connected to radio devices 1202, 1252, respectively.

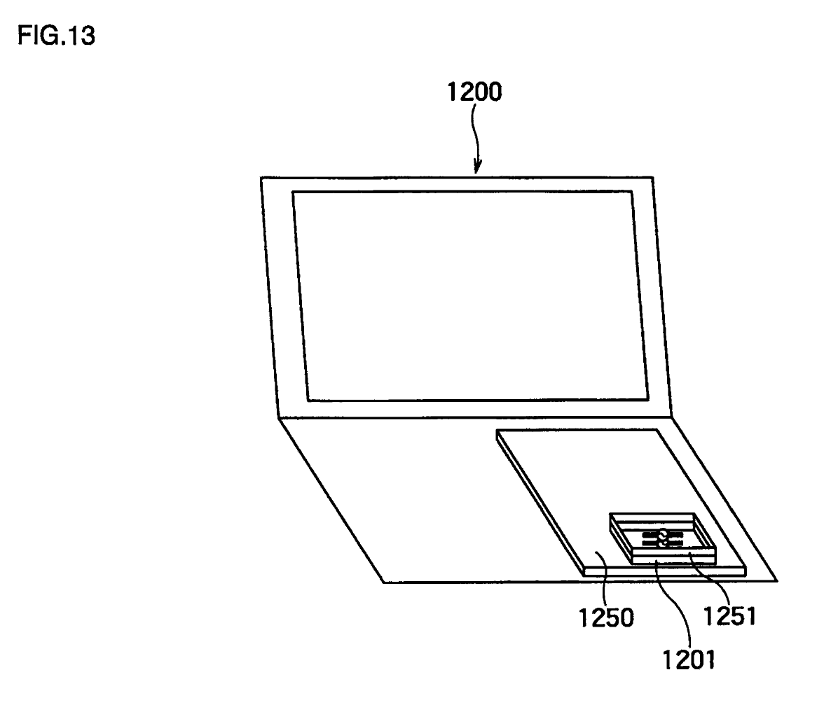

In FIG. 13, the radio apparatus 1250 is piled on the radio apparatus 1200. The radio devices 1202, 1252 are not shown for simplicity.

Since the antenna devices 1201, 1251 are close to each other, the leaked radio wave is less. Therefore, this location of the antenna devices 1201, 1251 is suits to communication of the confidential data. Moreover, robust communication is realized as described in FIG. 4 in the first embodiment.

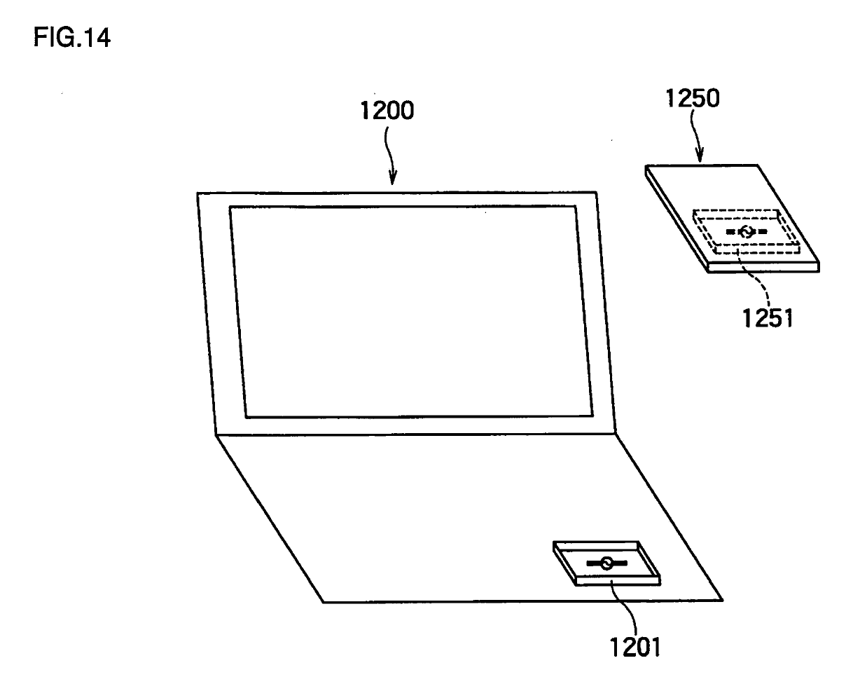

In FIG. 14, the radio apparatus 1250 is located away from the radio apparatus 1200. The radio devices 1202, 1252 are not shown for simplicity.

In this location, the antenna devices 1201, 1251 work as the antenna with reflector as described in FIG. 2 in the first embodiment. Therefore, the robust communication is realized even in the communication with far distance.

When the radio apparatus 1250 tries to start communication with the radio apparatus 1200, the radio apparatus 1250 is placed close to the radio apparatus 1200 in order to communicate the confidential data. After finishing communication of the confidential data, the radio apparatus 1250 can be moved to other place to be easy to use for a user. Or, the radio apparatus 1250 may keep being close to the radio apparatus 1200.

According to the sixth embodiment, the wireless communication system realizes both communications in the secure mode and in the normal mode without controlling the power or having the dedicated antenna device for the confidential data in addition to an antenna device to transmit/receive other data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An antenna device, comprising:
a ground plane;
an antenna element having a distance of (m×λ/2-λ/4) away from the ground plane, “m” being an integer which is equal or larger than “1”, “λ” being a wave length of operating frequency; and
a metal wall surrounding the antenna element, one end being attached to along the ground plane, the other end forming an aperture with a height from the ground plane, the height being (n×λ/2) where “n” is an integer which is equal or larger than “m”.

2. The antenna device of claim 1, further comprising:
a metal flange attached on other end of the metal wall.

3. The antenna device of claim 1, further comprising:
a second antenna element located at a position of (m×λ/2-λ/4) away from the ground plane, “m” being an integer which is equal or larger than “1”, “λ” being the wave length of operating frequency; and
a second metal wall surrounding the second antenna element, sharing part of side wall with the metal wall, one side being attached to along the ground plane, the height being (n×λ/2) where “n” is an integer which is equal or larger than “m”.

4. The antenna device of claim 1, wherein inside of the metal wall is filled with dielectric substrate and the antenna element is fixed in the dielectric substrate.

5. The antenna device of claim 4, wherein the metal wall includes several metal plates.

6. The antenna device of claim 4, wherein the metal wall includes several via holes.

7. A wireless communication system comprising:
a first radio apparatus and a second radio apparatus, the first radio apparatus communicates with the second radio apparatus in a secure mode and a normal mode, wherein
each of the first and second radio apparatuses includes the antenna device of claim 1,
the apertures of the first and second radio apparatuses are facing and touching each other in the secure mode; and
the apertures of the first and second radio apparatuses are separated away from each other in the normal mode.
